(19) United States
(12) Patent Application Publication
(10) Pub. No.: US 2011/0107651 A1
(43) Pub. Date: May 12, 2011

(54) SLIP SINKER

(76) Inventor: Ronald Alan Goodsite, Tucson, AZ (US)

(21) Appl. No.: 12/773,591

(22) Filed: May 4, 2010

Related U.S. Application Data
(60) Provisional application No. 61/280,801, filed on Nov. 9, 2009.

(51) Int. Cl. A01K 95/00

(52) U.S. Cl. 43/4.5; 43/44.87; 43/43.14

(57) ABSTRACT

The invention is directed to a weight for a fishing line and a method of weighting a fishing line with a sinker. One embodiment of the invention is directed to a weight for a fishing line comprising a length of metallic, inelastic material, the length of material configured into the shape of a coil having an internal coil diameter adapted to accommodate fishing line, the coil comprising a series of loops wherein the spacing between each pair of adjacent loops can be altered by manual application of a transient longitudinal, transverse, or rotational force. The coil may be configured in the field such that it acts as a pure “slip” sinker, it can be partially restrained, or it can be fully immobilized at a given point on the fishing line.

### CROSS REFERENCE TO RELATED APPLICATIONS

This application claims priority to U.S. Ser. No. 61/280,801, filed Nov. 9, 2009, incorporated herein by reference.

### BACKGROUND

The field of the invention disclosed herein is in that of fishing equipment. More specifically, the embodiments of the invention describe a slip sinker fashioned in the shape of a coil that can be manually adjusted in the field to have different line-retaining characteristics. A fishing sinker is a weight attached to the fishing line, at various distances above, or below, the hook. This weight keeps either live bait or lures (artificial flies, artificial worms, plugs, fish eggs, power bait, etc. . . . ) down in the water and also helps in casting the line further away from the fisherman when the fisherman is on shore. Weights come in varying shapes and sizes, depending upon the type and size of fish the angler is trying to catch. In most cases when a weight is attached to the fishing line, the weight either is “pinched” onto the line where it remains attached to the line in one place, or the line is threaded through a hole in the sinker or through a small ring attached to the sinker. In the case of a line threaded through the weight, the weight then can slide freely along the line, offering little resistance when a fish takes the bait or lure thereby allowing the fisherman to “set the hook” more quickly than if the fish feels resistance and is “spooked” from taking the bait or lure. For the fly fisherman using a floating fly line, a very small “split shot” weight can be attached to the front part of the fly line known as the leader in order to move the lure deeper under the water without the fisherman having to change to a “sinking” fly line. Nearly all weights which are used in the “slip-sinker” mode need the line threaded through the weight itself and the line then re-tied to either a swivel or a hook in order to keep the weight from coming off the line. For the fisherman looking to change sinker types (as from a fixed sinker to a slip sinker) it usually requires him to cut and to retie the fishing line. If the weather is especially cold and/or the light is poor, the fisherman may have difficulty when attempting to make a change to the sinker. In the case of a child, the task may be technically too difficult to accomplish successfully. There is a need for an improved fishing weight that solves the problems.

### SUMMARY OF THE INVENTION

The invention is directed to a weight for a fishing line. Such weights are also known as sinkers, and the two terms are used interchangeably throughout this description. One embodiment of the invention is directed to a weight for a fishing line comprising a length of metallic, inelastic material, the length of material configured into the shape of a coil having an internal coil diameter adapted to accommodate fishing line, the coil comprising a series of loops wherein the spacing between each pair of adjacent loops can be altered by manual application of a transient longitudinal, transverse, or rotational force. The coil may be configured in the field such that it acts as a pure “slip” sinker, it can be partially restrained, or it can be fully immobilized at a given point on the fishing line. The three different field-configurable embodiments of the invention are a significant aspect of its utility.

An embodiment is also directed to a method for weighting a fishing line with a sinker, the method comprising the steps of threading a coiled sinker onto a fishing line beginning at one end of the coil by threading the line successively between each pair of adjacent loops, whereby the fishing line extends through the entire length of the inner diameter of the coiled sinker, and applying force to the sinker to decrease the space between at least two adjacent loops to a distance less than the diameter of the fishing line, thereby preventing the sinker from slipping off the line and allowing the sinker to move along the line.

### BRIEF DESCRIPTION OF THE DRAWINGS

FIG. 1 is a side view of the extended form of the coiled slip sinker, with the distance between loops atypical for purposes of illustration.

FIG. 2 is a side view of the coiled slip sinker with fishing line in the process of being threaded through the loops.

FIG. 3 is a side view of the coiled slip sinker with fishing line threaded through the loops of the sinker.

FIG. 4 is a side view of the coiled slip sinker fully compressed so as to retain the fishing line within the diameter of the coil, yet allow free movement longitudinally.

FIG. 5 is a side view of a second embodiment of the invention wherein the fishing line is wrapped once around a single loop, and the adjacent loops are compressed inwards toward the line thereby capturing the sinker in place.

FIG. 6 is a third embodiment of the invention wherein the fishing line bypasses the interior of the coiled sinker for several loops, and the adjacent terminal loops are compressed inwards thereby capturing the line on the sinker.

### DETAILED DESCRIPTION OF EMBODIMENTS OF THE INVENTION

The invention is directed to a weight for a fishing line. Such weights are also known as sinkers, and the two terms are used interchangeably throughout this description. One embodiment of the invention is directed to a weight for a fishing line comprising a length of metallic, inelastic material, the length of material configured into the shape of a coil having an internal coil diameter adapted to accommodate fishing line, the coil comprising a series of loops wherein the spacing between each pair of adjacent loops can be altered by manual application of a transient longitudinal, transverse, or rotational force. The coil may be configured in the field such that it acts as a pure “slip” sinker, it can be partially restrained, or it can be fully immobilized at a given point on the fishing line. The three different field-configurable embodiments of the invention are a significant aspect of its utility. Another aspect is its environmental attractiveness, i.e., if the sinker material has no lead or other deleterious heavy metal, then it will not add to the lead in the environment.

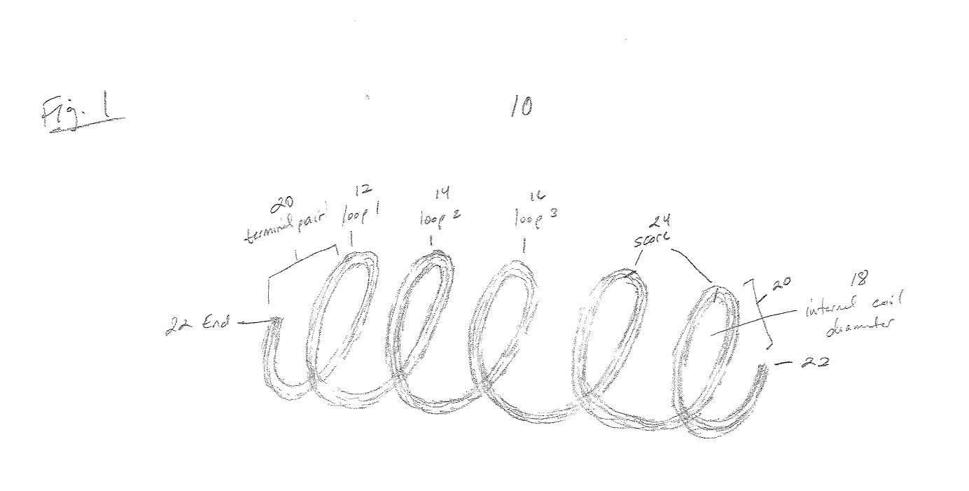

Referring to FIG. 1, weight 10 comprises a coiled length of a metallic, inelastic material. This material must be sufficiently dense that it is capable of weighting a fishing line towards the bottom of a body of water when the material is used in lengths and wire diameters that are appropriate for fishing. The sinker may also include scores or partial depressions 24, which are deep enough to allow the material to be manually broken. The fisherman can thereby customize the length of the sinker to particular fishing conditions and requirements. The type of material used will typically determine the wire diameter, as is discussed below. In accordance with the invention, the material must be sufficiently inelastic that its loops can be compressed or elongated by application of manual force. This may be done either by hand or with the use of tools commonly present while fishing (e.g. pliers).

As is shown in FIG. 1, the length of material used to form the weight 10 is in a coiled configuration, thereby creating a series of loops 12, 14, and 16. The internal coil diameter 18 is the space formed by the inner diameters of this series of loops and must be sufficiently large to accommodate fishing line. Commercially available fishing lines that will typically be used with the present invention will have diameters ranging from 0.005-0.030 inch.

When using the present invention, a fisherman may want to either decrease or increase the distance between a pair of adjacent loops (e.g. 12 and 14) or between multiple pairs of adjacent loops (e.g. 12 and 14 and 16). This is done to effect a pure slip sinker configuration, a partially restrained configuration, or a fixed configuration. The applied force may be longitudinal, transverse or rotational in relation to the long axis of the sinker, which runs parallel to the length of the internal coil diameter 18. The preferred direction of compression of the coil is longitudinal, which has the advantage of creating the least material fatigue. Furthermore, after applying the force to achieve desired distances between adjacent loops, the sinker should be able to maintain those desired distances without returning to any predetermined shape. Additionally, the fisherman may wish to initially alter the sinker's shape in one manner (e.g. decreasing the distance between adjacent loops) and then at a later time alter the same sinker's shape in another manner (e.g. increasing the distance between adjacent loops). Thus, the sinker should exhibit plastic deformation, rather than elastic deformation, in response to manually applied forces. The sinker should therefore be comprised of a material that is both sufficiently inelastic to exhibit this behavior and sufficiently dense to exhibit the necessary weight described above.

One material that exhibits these properties is solder. Solder is a metal alloy that is well known to one of ordinary skill in the art and typically comprises alloys of lead and tin in varying compositions. Alloys that include copper, bismuth, antimony, silver, indium, gold, zinc, and cadmium are also known in the art. Wire diameters ranging from 0.01-0.25 inch are often commercially available. For the present invention, wire diameters at the middle to upper end of this range are preferred because they will provide a heavier sinker for a given length of solder. A particularly preferred wire diameter is approximately 0.125 inch.

Alloys similar to solder may also be used that comprise any of the aforementioned materials in addition to other metals with similar properties including cobalt, nickel, platinum, and thallium. Any of the aforementioned metals in their pure forms may also be used in the present invention. These alloys or pure metals will also need to be used in diameters similar to that of commercially available solder. As previously noted, one criterion for selection of a particular metal is that it be manually deformable in the field. It is also desirable that the solder be smooth such that it does not wear the fishing line inordinately.

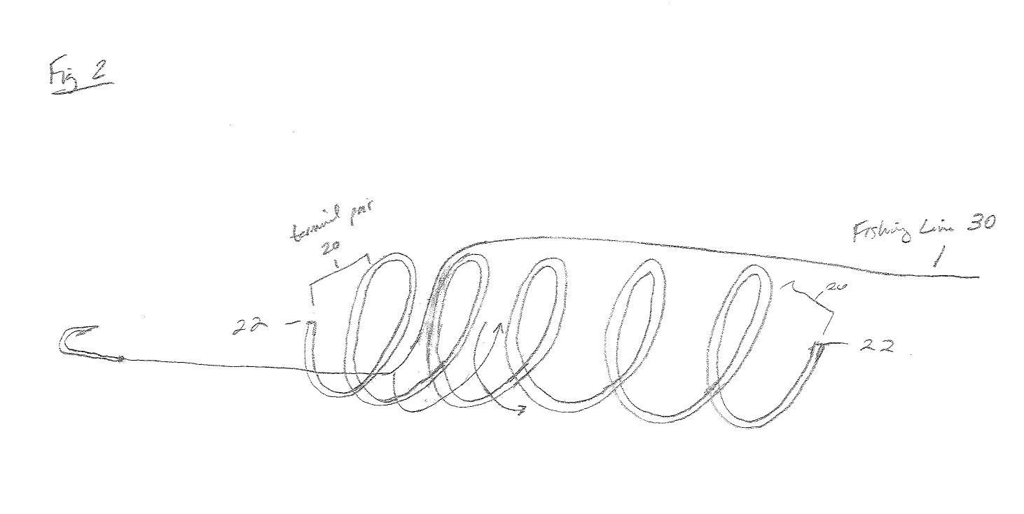

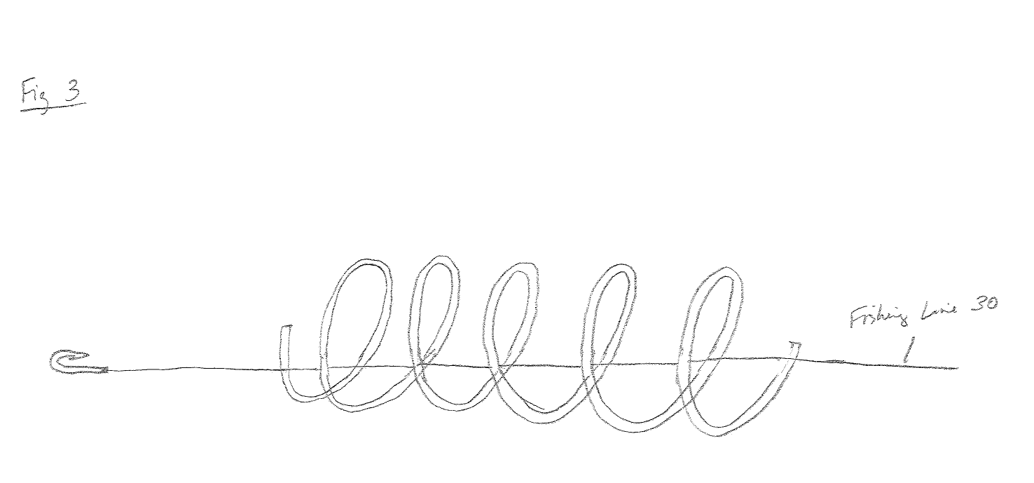

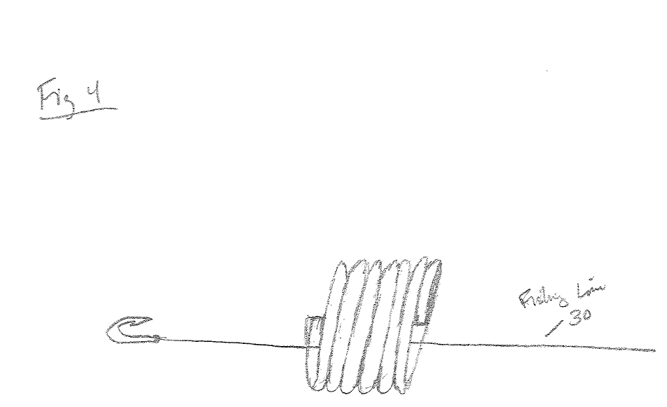

In one embodiment of the invention, the sinker may be used as a slip sinker. Slip sinkers provide the necessary weight to weight the fishing line towards the bottom of a body of water, but they also move freely along the fishing line, rather than remaining stationary in one position along the fishing line. First the fisherman may attach the sinker to the fishing line without cutting the fishing line 30 by threading the fishing line 30 through a terminal pair of adjacent loops 20 at either end 22 of the sinker. As shown in FIG. 2, the fisherman will then proceed to thread the fishing line 30 through each successive pair of adjacent loops until the fishing line exits from the terminal pair of adjacent loops at the opposite end of the sinker. After completing this process, the fishing line 30 will run through the entire length of the internal coil diameter 18, and the sinker will freely move along the length of fishing line (FIG. 3). To prevent the sinker from accidentally becoming detached from the fishing line, the fisherman may then apply manual force to the sinker to decrease the space between one or multiple pairs of adjacent loops to less than the diameter of the fishing line (FIG. 4). Though the sinker will not come off the line, it will still be able to move freely along the line. If the fisherman wishes to detach the sinker without cutting the line, he simply reverses the process used previously. The fisherman first applies manual force to the sinker to increase the spaces between all pairs of adjacent loops to a distance greater than the diameter of the fishing line. The fisherman will then employ the threading process described above in the reverse direction to detach the sinker from the fishing line.

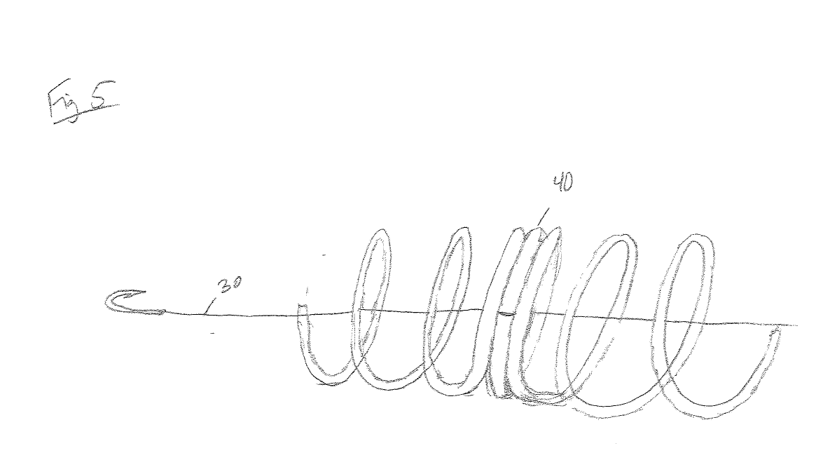

In another embodiment of the invention shown in FIG. 5, the sinker may be used as a stationary sinker. In this embodiment, the sinker is attached in a similar manner to the slip sinker embodiment previously described. However, in the process of threading the sinker onto the line 30, the fisherman will also wrap the line around at least one of the loops 40. Initially, this will prevent the sinker from moving as freely along the line as the slip sinker embodiment. The amount of friction generated between the line and the sinker may be modified by varying the number of sinker coils the line is wrapped around, and also by varying the distance between the enwrapped coils. However, upon the fisherman's application of a manual force (e.g., longitudinal compression) to the sinker that decreases the spaces next to the loop around which the fishing line is wrapped, the sinker will no longer be able to move along the line (FIG. 5). Rather, it will be held in place in a position along the line determined by the fisherman. Again, to remove the sinker without cutting the line, the fisherman simply employs a process that is the reverse of the attachment process.

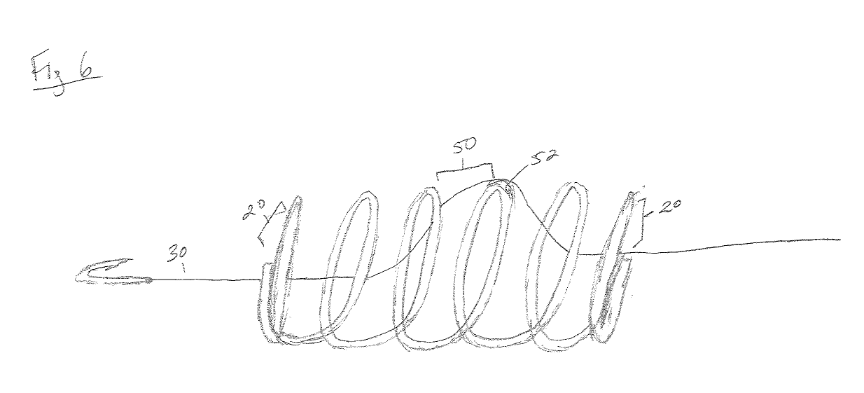

In a third embodiment, the sinker may be used as a modified slip sinker that can move along the line, but not as freely as in the slip sinker embodiment. The sinker is first attached to the fishing line in a process similar to that described for the slip sinker. However, as shown in FIG. 6, in this process the fisherman will refrain from threading the fishing line 30 between one of the pairs of adjacent loops 50 that is not a terminal pair 20. After the fisherman subsequently applies a manual force to the sinker to decrease the space between both terminal pairs 20 to a distance less than the diameter of the fishing line, the sinker will move along the line with some resistance without accidentally becoming detached from the line. The resistance results from the fact that the fishing line does run entirely through the length of the internal coil diameter 18, but rather runs over one of the loops 52 and extends partially outside of the coiled sinker.

The following examples are illustrations of the embodiments of the inventions discussed herein, and should not be applied so as to limit the appended claims in any manner.

An embodiment of the invention used Oatey brand Safe-Flo® silver solder wire, Part No. 53062, ¼ lb. solder (Oatey Co., Cleveland, Ohio), which consists of an alloy of tin (>90%), copper (<5%), bismuth (<5%), and silver (<5%). The wire diameter was 0.117 inch. The coiled sinker made from this wire consisted of approximately 4-5 loops, had an overall length of approximately 0.5 inch when fully compressed, and had an inner coil diameter of approximately 0.125 inch. This sinker can be used with any fishing line, for example Berkley TRILENE™ brand 6 lb. test fishing line (Bass Pro Shops, PN 38-421-090-06) which has a diameter of 0.010 inch, in any of the aforementioned embodiments.

It will be understood that various modifications may be made to the embodiments disclosed herein. Therefore, the above description should not be construed as limiting, but merely as exemplifications of preferred embodiments. Those skilled in the art will envision other modifications that come within the scope and spirit of the claims appended hereto. All patents and references cited herein are explicitly incorporated by reference in their entirety.

I claim:

1. A weight for a fishing line comprising a length of metallic, inelastic material, said length of material configured into the shape of a coil with an internal coil diameter adapted to accommodate fishing line, said coil comprising a series of loops wherein the spacing between each pair of adjacent loops can be altered by manual application of a transient longitudinal, transverse, or rotational force.

2. The weight of claim 1, wherein the spacing between the adjacent loops is greater than or equal to the diameter of the fishing line, thereby allowing attachment of the weight to the line without cutting the line.

3. The weight of claim 1, wherein the spacing between at least one pair of adjacent loops is less than the diameter of the fishing line, thereby preventing detachment of the weight from the line.

4. The weight of claim 1, wherein the material is scored in at least one location to a depth enabling manual separation.

5. The weight of claim 1 wherein the material is selected from the group consisting of lead, tin, bismuth, antimony, silver, gold, copper, zinc, indium, cobalt, nickel, platinum, cadmium and thallium, and alloys thereof.

6. The weight of claim 1, wherein the material comprises solder.

7. The weight of claim 1, wherein the longitudinal, transverse, or rotational force is applied by hand.

8. The weight of claim 1 wherein the spacing between the adjacent loops is less than the diameter of the fishing line, thereby retaining the weight on the line.

9. A method for weighting a fishing line with a sinker, said method comprising the steps of threading a coiled sinker onto a fishing line beginning at one end of the coil by threading the line successively between each pair of adjacent loops, whereby the fishing line extends through the entire length of the inner diameter of the coiled sinker, and applying force to the sinker to decrease the space between at least two adjacent loops to a distance less than the diameter of the fishing line, thereby preventing the sinker from slipping off the line and allowing the sinker to move along the line.

10. The method of claim 9, wherein the force is manually applied.

11. The method of claim 9, wherein the applied force decreases the spaces between all adjacent loops to a distance less than the diameter of the fishing line.

12. The method for weighting a fishing line with a sinker of claim 9 comprising the additional step of wrapping the line around at least one of the loops.

13. A method for weighting a fishing line with a sinker, said method comprising the steps of threading a coiled sinker onto a fishing line beginning at one end of the coil, threading the line successively between all but one of the pairs of adjacent loops, which is not one of the terminal pairs at either end of the sinker, and applying force to the sinker to decrease the space between the two adjacent loops at each end of the sinker to a distance equal to or less than the diameter of the fishing line, thereby preventing the sinker from falling off the line and allowing the sinker to move along the line.

14. The method of claim 13, wherein the force is manually applied.

15. The method of claim 13, wherein the applied force decreases the spaces between all adjacent loops to a distance less than the diameter of the fishing line.
